(19) United States
(12) Patent Application Publication
(10) Pub. No.: US 2007/0043133 A1
(43) Pub. Date: Feb. 22, 2007

(54) Polyurethane foams, processes for obtaining them and use of these foams

(76) Inventors: Quintino Carvalho, Lyon (FR); Marlise Margaritelli, Paraiso (BR); Luciane Sereda, Cambui (BR)

Correspondence Address: Jean-Louis Seugnet;Rhodia Inc-Legal Department, 8 Cedar Brook Drive, CN 7500, Cranbury, NJ, 08512-7500, US

(21) Appl. No.: 10/567,704

(22) PCT Filed: Jul. 30, 2004
(86) PCT No.: PCT/FR04/02055

§ 371 Date: Oct. 31, 2006

(30) Foreign Application Priority Data
Aug. 8, 2003 (FR) 03 09781
Sep. 23, 2003 (FR) 03 11115

(51) Int. Cl. C08G 18/00

(52) U.S. Cl. 521/172

(57) ABSTRACT

The present invention relates to polyurethane foams used especially for manufacturing moulded articles such as soles for various types of shoe. The invention relates more particularly to a low-density polyurethane foam whose mechanical properties are suitable for use as shoe soles and even more particularly for sports shoe soles or platform-sole shoes worn especially by women.

The present invention relates to polyurethane foams used especially for manufacturing moulded articles such as soles for various types of shoe.

The invention relates more particularly to a low-density polyurethane foam whose mechanical properties are suitable for use as shoe soles and even more particularly for sports shoe soles or platform-sole shoes worn especially by women.

Polyurethane foams are used in many applications and may be classified in two types: rigid foams and flexible foams. The field of the present invention concerns flexible polyurethane foams.

One of the important applications of these flexible foams is the manufacture of soles for shoes, especially for sports shoes, and women's shoes of the platform type. More particularly, polyurethane foams are used for manufacturing a portion of a shoe sole known as the midsole.

In these applications, the sole must have good compressive strain, hardness and high tear strength, but must also be comfortable for the user.

Polyurethane foams adapted to these applications have already been proposed.

However, to obtain a level of suitable properties, the polyurethane foam must have a density of at least about 0.35 g/cm³, which does not make it possible to produce soles equivalent in weight to those obtained with a vinyl acetate copolymer (EVA).

There is a problem of being able to produce articles made of very low density polyurethane foam, to obtain articles equivalent in weight to those obtained with EVA, while at the same time conserving the level of properties of the polyurethane foams, these properties not being achievable with EVA soles.

One of the aims of the present invention is to propose a novel polyurethane-based foam that has properties suitable for the desired applications, especially the manufacture of midsoles, and that has a low density relative to the polyurethane foams of the prior art, in order thus to allow the manufacture of low-weight articles with good properties.

To this end, one of the objects of the invention is a flexible polyurethane foam obtained by reaction between a polyesterdiol and a diisocyanate compound, characterized in that it has a density of less than 0.3 g/cm³, an Ascher C hardness of greater than or equal to 45 and a compression set of less than or equal to 12%.

Advantageously, the foam of the invention has a tensile breaking stress of greater than or equal to 18 kg/cm².

According to one preferred characteristic, it has a tear strength of greater than or equal to 2.5 kg/cm and, advantageously, a moulding shrinkage of less than or equal to 1.0%.

These characteristics and properties are determined by the methods described in the following standards:
The density, also known as the apparent density, is determined according to ASTM standard D 3574 (A) (Cellular plastics and rubbers—Determination of apparent density, corresponding to ISO standard 845).
The hardness is determined according to NBR standard 14455 (Ascher C) (Cellular materials, materials for soles and parts of shoes, corresponding to DIN standard 53543) using an Ascher C durometer.
The tear strength of the foam is determined according to ASTM standard D 3574 (F).
The tensile breaking stress is determined according to ASTM standard D 412.
The elongation at break is determined according to ASTM standard D 412 (C).
The moulding shrinkage is measured according to SATRA standard TM 70 (Heat shrinkage of cellular soiling).
The compression set is determined according to ASTM standard D 395 (B) (Flexible cellular polymeric materials, corresponding to ISO standard 1856).

According to one preferred characteristic of the invention, the density of the foam is between 0.1 g/cm³ and 0.25 g/cm³ and advantageously between 0.15 g/cm³ and 0.23 g/cm³.

According to one preferential characteristic of the invention, the polyurethane foam comprises a dispersed mineral particulate filler, the weight concentration of the said filler being between 0.6% and 8% and preferably between 0.6% and 5% relative to the weight of the foam.

The polyurethane foams of the invention are obtained by reaction between a compound comprising at least two isocyanate functions, and a polyesterdiol compound. Advantageously, and usually, the isocyanate compound is a prepolymer comprising isocyanate end functions. The molar ratio between the isocyanate and hydroxyl functions is between 1.0 and 1.5 and advantageously between 1.2 and 1.5.

By way of illustration, the isocyanate compounds that are suitable for the invention may be aromatic, saturated or unsaturated cyclic, or aliphatic. The preferred isocyanate compounds usually used in the manufacture of foams, especially polyurethane foams, are prepolymers obtained by reaction of polyesterpolyol or polyetherpolyol with two molecules of diisocyanates. In this case, it is common to refer to these compounds as isocyanate prepolymers.

The diisocyanates that are suitable especially for the manufacture of isocyanate prepolymers comprise aromatic isocyanates, such as toluene diisocyanate, xylylene diisocyanate, polymethylene polyphenylene diisocyanate, saturated cyclic isocyanates such as hydrogenated methylenediphenyl diisocyanate, hydrogenated toluene diisocyanate, and isophorone diisocyanate, aliphatic diisocyanates such as hexamethylene diisocyanate, and lysine diisocyanate.

The preferred isocyanate prepolymers usually used are those comprising a flexible segment formed by a polyoxyalkylene glycol that has reacted with methylenediphenyl diisocyanate. Such a compound is especially advantageous for the manufacture of a low-density foam, especially the foams of the invention.

The polyesterdiols that are suitable for the invention are generally obtained by reaction between dicarboxylic acids containing from 2 to 12 and preferably from 4 to 6 carbon atoms, and at least one diol.

Examples of dicarboxylic acids that may be mentioned include aliphatic diacids such as adipic acid, succinic acid, glutaric acid, suberic acid, azelaic acid and sebacic acid, and aromatic acids such as phthalic acid, isophthalic acid, terephthalic acid and naphthenic acid. These diacids may be used individually or as a mixture.

According to one preferred embodiment of the invention, the diacid used is a mixture of diacids containing at least 6 carbon atoms, such as adipic acid, and at least one diacid containing 5 carbon atoms or less, advantageously glutaric acid, especially the mixture of adipic acid, glutaric acid and succinic acid.

According to another more preferred embodiment of the invention, the diacids used for the formation of the polyesterdiol advantageously consist of a mixture of adipic acid and a mixture of diacids known as AGS obtained as a by-product in the process for manufacturing adipic acid by oxidation of cyclohexanol and/or cyclohexanone and which comprises adipic acid, glutaric acid and succinic acid.

It is also possible to use derivatives of these diacids, such as diesters containing from 1 to 4 carbon atoms for the residue derived from the alcohol, acid anhydrides and acid chlorides.

As diols that are suitable for the invention, mention may be made of glycols containing from 2 to 10 carbon atoms and preferably from 2 to 6 carbon atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol, dipropylene glycol, trimethylpropanol, Bisphenol and 1,1,3-trimethyltriethylenediol.

It is also possible to use esters of these diols with the diacids described above, especially those containing from 4 to 6 carbon atoms, the products of condensation of hydroxycarboxylic acids such as hydroxycaproic acid, the products of polymerization of lactones such as caprolactone; the polyesterdiols that are particularly preferred for the invention are poly(ethanediol adipates), poly(1,4-butanediol adipates), poly(1,6-hexanediol adipate-neopentyl glycol), poly(1,6-hexanediol adipates), poly(1,4-butanediol adipates) and polycaprolactones. These polyesterdiols advantageously having a number-average molecular weight of between 5000 and 8000 are preferred.

According to one preferred characteristic of the invention, the polyurethane foam contains a dispersed particulate mineral filler.

As mineral particulate fillers that are suitable for the invention, examples that may be mentioned include fillers with particle sizes of less than 60 μm, preferably less than 20 μm and even more advantageously less than 10 μm.

Thus, as fillers that are suitable for the invention, mention may be made of aluminosilicate powder, silica powder, titanium oxide powder, talc powder, kaolin powder or calcium carbonate powder, for example.

According to one preferred embodiment of the invention, silicas and more particularly silicas obtained especially by precipitation are the preferred fillers.

Another subject of the invention is a process for manufacturing polyurethane foams comprising a dispersed mineral particulate filler, characterized in that the particles of the said mineral filler are predispersed in the polyesterdiol, the polyurethane foam being obtained by reaction between a diisocyanate compound and a mixture of a composition formed by a suspension of the said particulate filler in a polyesterdiol in the presence of a catalyst and of a foam-forming agent present in an amount required to obtain the desired density.

Advantageously, a chain extender and surfactants may be added to the foam-forming reaction medium.

According to one preferential characteristic of the invention, the suspension of mineral filler particles in the polyesterdiol may be obtained by adding the said particles to the polyesterdiol esterification reaction medium or to the reaction medium at the start of the polycondensation step.

Thus, the mineral filler may be added directly to the medium, either in the form of a premix with the diol or, according to one preferred embodiment of the invention, in the form of a premix with at least some of the diacids.

Thus, by performing this process, very good dispersion and suspension of the mineral filler particles in the polyesterdiol, and thus very good dispersion in the polyurethane foam that will be obtained with this dispersion, are obtained.

According to one preferred characteristic of the invention, the weight concentration of mineral fillers in the premix with the diacids is between 2% and 20% and preferably between 2% and 12%. The concentration of mineral filler in the polyesterdiol is between 1% and 18% by weight and preferably between 1% and 10% by weight.

Furthermore, the process of the invention, especially the process for introducing the mineral filler in the form of a mixture with the diacids, makes it possible to obtain a stable dispersion. It is thus possible via the process of the invention to prepare polyesterpolyol-based dispersions and to store them before their use for the manufacture of polyurethane foam.

In the preferred embodiment of the invention, the mixture of the filler with the diacids may be obtained by mixing diacid granules or powders with the mineral filler particles, at room temperature, for example, or at a temperature of between room temperature and 120° C.

It is also possible to coat the mineral filler particles with some of the diacids. This coating is obtained by heating the mixture to a temperature above the melting point or softening point of the diacids.

In this embodiment, the mineral filler particles are advantageously coated with a diacid containing less than 5 carbon atoms, for instance glutaric acid, or a mixture of diacids containing a diacid containing less than 5 carbon atoms, such as the diacid mixture known as AGS.

It is also possible to add other additives usually used in the formation of polyurethane foams to this mixture or to the polyesterdiol.

The process described above is particularly advantageous for the manufacture of the polyurethane foams of the invention, especially for obtaining a level of mechanical and working properties that are suitable for low-density foams.

Specifically, it is important, in order to obtain a compromise of properties for polyurethane foams with a density of less than 0.3 g/cm³ and especially for foams with a density of less than 0.25 g/cm³, to use reinforcing mineral fillers uniformly distributed in the foam.

In addition, the use of a mixture of diacids comprising a diacid of less than 5 carbon atoms as a mixture with a diacid of more than 5 carbon atoms may make it possible to improve certain mechanical properties of the polyurethane foam, for instance the elongation at break, the hardness and the tear strength of the foams. This effect is especially advantageous and important for compensating for the decrease in the elongation at break generated by the addition of a mineral filler. It has been found that in the presence of a polyesterdiol obtained from a mixture of diacids as described above and for a certain mineral filler concentration range (high concentration), the elongation at break is increased.

According to one preferential embodiment of the invention, the mineral filler is an amorphous silica, especially a silica obtained by precipitation. These silicas are in the form of aggregated particles advantageously less than 50 μm in size or diameter.

Precipitated silicas are preferred since they may be in the form of aggregated particles forming granules of at least 50 μm or greater than 150 μm in size. These aggregates readily disintegrate under the action of a stirring force or shear force to give particles less than a few microns in size, for example less than 5 μm, especially during mixing with the diacids or polyols.

These aggregates may be in the form of substantially spherical beads or granules, obtained, for example, by spraying, as described in European patent No. 0 018 866.

This silica is sold under the generic name Microperle. Such silicas with noteworthy flowability and dispersibility properties and high impregnation capacity are described especially in European patents 966 207, 984 773 and 520 862 and international patent applications WO 95/09187 and WO 95/09128.

Other types of silica may be suitable for the invention, for instance those described in French patent application No. 01 16881, which are fumed silicas or silicas partially dehydroxylated by calcination or by a surface treatment.

These examples of silicas used as solid mineral substrate are described merely as a guide and as preferred embodiments. It is also possible to use other silicas obtained via other processes, having porosity and dispersibility properties that are suitable for performing the invention.

The amount of mineral filler in suspension in the polyesterdiol or as a mixture with the diacids is chosen as a function of the desired mineral filler concentration in the polyurethane foam.

According to another subject of the invention, the polyesterdiols containing a mineral filler are obtained according to a manufacturing process comprising two steps, a first step of esterification and a second step of polycondensation.

The esterification step is performed by mixing the diacids with diols, for example a mixture of ethylene glycol and diethylene glycol with a diol/diacid molar ratio of between 1.2 and 1.5.

The reaction temperature in this first step is gradually increased as the reaction proceeds. For example, the start of the reaction is performed at a temperature of 160° C., to arrive at a temperature of 220° C. at the end of the reaction.

According to the invention, the diacids are advantageously added as a mixture with the mineral filler.

The second step of polycondensation is performed with addition of a catalyst such as tetrabutyl titanate (TBT) in a weight concentration advantageously of between 0.001% and 0.010% relative to the weight of diacids used. The polymerization temperature is 200° C. at a pressure of between 10 and 20 mbar.

The polyesterdiol obtained is characterized by the hydroxyl number (I_{OH}), corresponding to the number of milligrams of potassium hydroxide per gram of polyol to convert the hydroxyl functions into alkoxide, and the acid number (I_{A}), which represents the number of milligrams of KOH required to neutralize 1 g of polyol.

The polyesterdiol is also characterized by the viscosity and by its molecular weight.

Advantageously, an additive that limits or prevents the hydrolysis of the ester functions is added to the polyesterdiols, such as carboimides, for instance cyanamides; hydrogen cyanamide; carbimides; cyanogenamides; amidocyanogens.

It may also be advantageous to add UV-stabilizing additives such as hindered amines, antioxidants, flame retardants or the like to the polyesterdiols.

The polyurethanes of the invention are obtained according to the conventional and usual processes. Thus, the polyesterdiols of the invention are mixed with a chain extender, surfactants, for instance the compounds sold by the company Rhodia under the trade names Rhodorsil SP3301 and SP3300, and the diisocyanate compound, in the presence of a foam-forming or pore-forming agent and a catalyst.

Water, hydrocarbons, chlorofluorocarbons, hydrogenated fluorocarbons and carbon dioxide may be used, alone or as a mixture, as foam-forming agent. Water is the preferred foam-forming or pore-forming agent.

As catalysts that are suitable for the invention, mention may be made of tertiary amines such as 1,4-diazabicyclo(2,2,2)octane, N,N,N′,N′-tetramethylhexamethylenediamine; N,N,N′,N′-tetramethylpropylenediamine; N,N,N′,N′,N″-pentamethyldiethylenetriamine; trimethylaminoethylpiperazine; N,N-dimethylcyclohexylamine; N,N-dimethylbenzylamine; N-methylmorpholine; N-ethylmorpholine; triethylamine; tributylamine; bis(dimethylaminoalkyl)piperazines; N,N,N′,N′-tetramethylethylenediamine; N,N-diethylbenzylamine, bis(N,N-diethylaminoalkyl)adipate; N,N,N′,N′-tetramethyl-1,3-butanediamine; N,N-dimethyl-β-phenylethyldiamine, 1,2-dimethylimidazole; 2-methylimidazole, and the like. Other catalysts may be used, such as organometallic compounds, for instance dibutyltin dilaurate, tin oleate, cobalt naphthenate or lead naphthenate.

Other additives such as pigments, colouring agents or antioxidants may be added.

The mixture is injected into a mould to form the polyurethane foam and to obtain an article having the desired shape, for instance soles.

By adjusting the amount of foam-forming agent, for example the amount of water, it is possible to obtain foams with different densities, for example of between 0.1 and 0.3 g/cm³, advantageously between 0.1 and 0.25 g/cm³ and even more advantageously between 0.15 and 0.23 g/cm³.

The invention especially makes it possible to obtain polyurethane foams of low density, for example of about 0.2 g/cm³, leading to article whose mechanical and comfort properties are suitable for applications as shoe soles. These properties are especially suitable for the manufacture of midsoles for sports shoes, women's shoes or other types of shoe.

The compositions of the invention make it possible to obtain articles especially having high rebound and tear strength properties and also a level of hardness that allows the preparation of midsoles for shoes, especially sports shoes.

The rebound property is evaluated by determining the impact resilience or rebound, determined by the height of rebound of a ball falling onto the surface of the foam. This characteristic is expressed as a percentage corresponding to the height of rebound relative to the drop height of the ball.

These soles allow the comfort of shoes to be improved, with a sole weight equivalent to that of soles made of EVA.

Furthermore, the soles obtained with the compositions of the invention have improved service lives since the properties of resistance to ageing and the fatigue strength of the polyurethane foam relative to EVA soles limit the deterioration of the sole.

These advantages and properties will emerge more clearly in the light of the examples, which are given below purely for indicative purposes.

### COMPARATIVE EXAMPLES 1

A test of production of a polyurethane foam from formulations sold by the company Dow Chemicals under the name Voralast GF422 for the polyol and Voralast GS749 for the diisocyanate prepolymer was performed.

The polyurethane foam is obtained by mixing together the products listed in Table I in the weight proportions indicated.

TABLE I

| | Normal-density | Low-density |
|---|---|---|
| | foam (g) | foam (g) |
| Product | test 1 | test 1a |
| Polyol | 100 | 100 |
| Chain extender (MEG) | 14 | 8.17 |
| Foam-forming agent (water) | 0.1 | 0.64 |
| Catalyst | 1.2 | 1.57 |
| Surfactant | 0.2 | 0.47 |
| Isocyanate prepolymer | 129.3 | 124.0 |
| NCO/OH molar ratio | 1.128 | 1.124 |

The properties of the foams obtained, determined according to the standardized methods described above, are given in Table II below:

TABLE II

| | | | Tensile | | |
|---|---|---|---|---|---|
| | Apparent | | breaking | | Tear |
| | density | Hardness | stress | Elongation | strength |
| Test | (g/cm³) | (Ascher C) | kg/cm² | at break % | kg/cm |
| 1 | 0.35 | 64 | 24.6 | 284 | 6.4 |
| 1a | 0.20 | 31 | 13 | 289 | 5.1 |

These tests clearly show the effect on the mechanical properties of a reduction in the density of a polyurethane foam when the compounds used to form this form are identical, especially a very large reduction in the hardness.

### EXAMPLES 2

A polyurethane foam was obtained by using as polyol a polyesterdiol prepared according to the following procedure and as diisocyanate prepolymer the prepolymer of Example 1:

In a first step, adipic acid mixed with 6% silica is added to a mixture of ethylene glycol (MEG) and diethylene glycol (DEG) containing 70% by weight of MEG.

The molar ratio between the alcohols and the diacid is between 1.2 and 1.5.

The reaction is performed by heating the mixture at 160° C. for 1 hour and then raising the temperature in 15° C. stages up to 215° C. This reaction is performed under an inert atmosphere, for example of nitrogen.

The esterified material obtained is polycondensed in a second step after addition of tetrabutyl titanate (TBT) in a weight concentration of 0.003% relative to the amount of diacids added.

The polymerization is performed at 200° C. under a reduced pressure of 15-18 mbar.

The polyesterpolyol obtained is characterized by the OH number (I_{OH}), the acid number (I_{A}) and the viscosity.

The adipic acid/silica mixture is obtained by mixing adipic acid granules with a silica powder sold by the company Rhodia under the trade name Tixosil 365.

Two tests are performed with a different concentration of silica in the adipic acid:
Example 2A: 6% by weight of silica in the adipic acid/silica mixture
Example 2B: 9% by weight of silica in the adipic acid/silica mixture.

The characteristics of the polyesterpolyols obtained are:

### EXAMPLE 2A

ADOH/SiO₂ (mass ratio): 94/06
MEG/DEG (molar ratio): 70/30
I_{OH}: 58.5 mg of KOH/g polyol
I_{A}: 1.0 mg of KOH/g polyol
Viscosity: 8000 mPa·s at 35° C.

### EXAMPLE 2B

ADOH/SiO₂ (mass ratio): 91/09
MEG/DEG (molar ratio): 70/30
I_{OH}: 51.7 mg of KOH/g polyol
I_{A}: 0.90 mg of KOH/g polyol
Viscosity: 11 070 mPa·s at 35° C.

The polyurethane foams were obtained by using the compounds and proportions indicated in Table III below:

TABLE III

| Products | Proportion (g) |
|---|---|
| Polyol | 100 |
| Chain extender (ethylene glycol) | 8.83 |
| Water | 1.23 |
| Catalysts | 2.6 |
| Surfactant | 1.3 |
| Isocyanate prepolymer | 167 |
| NCO/OH molar ratio | 1.414 |

The properties of the forms obtained are:

### EXAMPLE 2A

Density: 0.21±0.01 g/cm³
Hardness (Ascher C): 49±1
Tensile breaking stress: 26.6±1.1 kg/cm²
Elongation at break: 280±8%
Tear-propagating breaking stress: 2.34±0.17 kg/cm
Tear strength: 9.9±0.5 kg/cm
Compression set: 3.8±0.4%

### EXAMPLE 2B

Density: 0.20±0.01 g/cm³
Hardness (Ascher C): 52±1
Tensile breaking stress: 24.23±1.60 kg/cm²
Elongation at break: 218±11%
Tear propagation resistance: 2.54±0.14 kg/cm
Tear strength: 9.50±0.40 kg/cm
Compression set: 3.0±0.5%

### EXAMPLES 3

Examples 3a and 3b are obtained by using, respectively, an acids/silica mixture containing, firstly, adipic acid and 6% by weight of silica and, secondly, a mixture containing adipic acid, 6% by weight of a mixture of diacids known as AGS and 6% by weight of silica.

The characteristics of the polyesterdiols obtained are:

### EXAMPLE 3A

ADOH/SiO₂ (mass ratio): 94/06
MEG/DEG (molar ratio): 70/30
I_{OH}: 57.7 mg of KOH/g polyol
I_{A}: 0.78 mg of KOH/g polyol
Viscosity: 7440 mPa·s at 35° C.

### EXAMPLE 3B

ADOH/SiO₂/AGS (mass ratio): 88/06/06
MEG/DEG (molar ratio): 70/30
I_{OH}: 54.7 mg of KOH/g polyol
I_{A}: 0.70 mg of KOH/g polyol
Viscosity: 8040 mPa·s at 35° C.

The polyurethane foam obtained according to the indications given in Table III has the following properties:

### EXAMPLE 3A

Density: 0.20±0.01 g/cm³
Hardness (Ascher C): 46±3
Tensile breaking stress: 24.00±3.30 kg/cm²
Elongation at break: 252±29%
Tear propagation resistance: 2.63±0.30 kg/cm
Tear strength: 10.5±0.7 kg/cm
Compression set: 3.3±0.6%

### EXAMPLE 3B

Density: 0.20±0.01 g/cm³
Hardness (Ascher C): 48±3
Tensile breaking stress: 24.10±2.30 kg/cm²
Elongation at break: 280±23%
Tear propagation resistance: 2.9±0.26 kg/cm
Tear strength: 10.2±0.8 kg/cm
Compression set: 4.9±0.4%

### EXAMPLES 4

Examples 4a and 4b are obtained by using, respectively, an acids/silica mixture containing adipic acid, 6% by weight of a mixture of diacids known as AGS and 6% by weight of silica. The mixture used in Example 4a is obtained by mechanical mixing of the various components.

The mixture used for the preparation of Example 4b is obtained by coating the mineral filler with the AGS diacid mixture and physical mixing with the adipic acid.

The characteristics of the polyesterpolyols obtained are:

### EXAMPLE 4A

ADOH/SiO₂/AGS (mass ratio): 88/06/06
MEG/DEG (molar ratio): 70/30
I_{OH}: 54.7 mg of KOH/g polyol
I_{A}: 0.70 mg of KOH/g polyol
Viscosity: 8040 mPa·s at 35° C.

### EXAMPLE 4B

ADOH/SiO₂/AGS (mass ratio): 88/06/06
MEG/DEG (molar ratio): 70/30
I_{OH}: 51.8 mg of KOH/g polyol
I_{A}: 0.70 mg of KOH/g polyol
Viscosity: 10 850 mPa·s at 35° C.

The polyurethane foam obtained according to the indications given in Table III has the following properties:

### EXAMPLE 4A

Density: 0.20±0.01 g/cm³
Hardness (Ascher C): 48±3
Tensile breaking stress: 24.10±2.30 kg/cm²
Elongation at break: 280±23%
Tear propagation resistance: 2.9±0.26 kg/cm
Tear strength: 10.2±0.8 kg/cm
Compression set: 4.9±0.4%

### EXAMPLE 4B

Density: 0.20±0.01 g/cm³
Hardness (Ascher C): 52±2
Tensile breaking stress: 23.00±1.70 kg/cm²
Elongation at break: 293±23%
Tear propagation resistance: 2.83±0.34 kg/cm
Tear strength: 10.1±0.7 kg/cm
Compression set: 5.6±0.8%

1-24. (canceled)

25. A flexible polyurethane foam obtained by reaction between a polyesterpolyol and a diisocyanate, having a density, determined according to ASTM standard D3574(A), of less than 0.3 g/cm³, a hardness, measured according to NBR standard 14455 (Ascher C), of greater than or equal to 45 and a compression set, determined according to ASTM standard D 395 (B), of less than or equal to 12%.

26. The foam according to claim 25, wherein the density is between 0.1 g/cm³ and 0.25 g/cm³, optionally between 0.15 g/cm³ and 0.23 g/cm³.

27. The foam according to claim 25, having a tear strength, measured according to ASTM standard D 3574 (F), of greater than or equal to 2.5 kg/cm.

28. The foam according to claim 25, having a tensile breaking stress, measured according to ASTM standard D 412, of greater than or equal to 18 kg/cm².

29. The foam according to claim 25, having an elongation at break, measured according to ASTM standard D 412 (C), of greater than or equal to 250%.

30. The foam according to claim 25, having a moulding shrinkage, determined according to SATRA standard TM 70, of less than or equal to 1.0%.

31. The foam according to claim 25, further containing a dispersed mineral particulate filler in a weight concentration of between 0.8% and 8% relative to the total weight of the foam.

32. The foam according to claim 31, wherein the mineral filler particles have a mean size of less than 60 μm.

33. The foam according to claim 32, wherein the particles have a mean size of less than 20 μm, optionally less than 10 μm.

34. The foam according to claim 31, wherein the mineral filler is aluminosilicate, silica, titanium oxide, talc, calcium carbonate, mica or kaolin.

35. The foam according to claim 34, wherein the mineral filler is a precipitation silica.

36. The foam according to claim 25, wherein the polyesterpolyol is obtained by reaction between a diol and a diacid or a mixture of diacids comprising at least adipic acid and at least one diacid having 5 carbon atoms or less.

37. The foam according to claim 36, wherein the diacid having less than 5 carbon atoms is glutaric acid.

38. A reactive extrusion process for manufacturing polyurethane foam as defined in claim 31, comprising the steps of: feeding in a diisocyanate compound, a composition formed by a suspension of mineral fillers in a polyesterdiol, a catalyst and a foam-forming agent, the said foam-forming agent being present in an amount required to obtain the desired density.

39. The process according to claim 38, wherein the composition formed by a suspension of mineral fillers in a polyesterdiol is obtained by reacting a diol compound with at least one diacid in an esterification step, followed by a polycondensation until the desired degree of polymerization is obtained, the diacid being adipic acid, and wherein the mineral filler is dispersed in or fed into the reaction medium either before the esterification step or at the start of the polymerization step.

40. The process according to claim 39, wherein the diacid is a mixture of adipic acid and of diacids having 5 carbon atoms or less.

41. The process according to claim 40, wherein the diacid is a mixture of adipic acid, glutaric acid and succinic acid.

42. The process according to claim 39, wherein the diacid is a mixture of adipic acid and AGS.

43. The process according to claim 42, wherein the adipic acid is present in the acid mixture in a concentration of between 2% and 20% by weight.

44. The process according to claim 39, wherein the mineral filler is added to the esterification medium as a mixture with at least some of the diacids.

45. A shoe midsole obtained by moulding a polyurethane foam as defined in claim 31.

46. The shoe comprising at least a portion of the sole as defined in claim 45.
